(19) United States
(12) Patent Application Publication
(10) Pub. No.: US 2006/0248757 A1
(43) Pub. Date: Nov. 9, 2006

(54) Greeting card integrating currency and conversational balloons

(76) Inventor: Blaine E. Myers, Swissvale, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/393,004

(22) Filed: Mar. 29, 2006

Related U.S. Application Data
(60) Provisional application No. 60/667,640, filed on Mar. 31, 2005.

(51) Int. Cl. G09F 1/00

(52) U.S. Cl. 40/124.06; 40/124.11

(57) ABSTRACT

A greeting card for holding currency includes (a) a print medium having a first and second side, wherein the print medium includes a first fold line; (b) means for securing the currency to the first side of the print medium to allow a visual indicia depicted on the currency to remain visible after the currency has been secured to the first side; (c) an opening defined within the print medium, wherein the opening allows the visual indicia of the currency to be visible therethrough when the print medium is folded along the first fold line; and (d) a first message printed on the second side of the print medium, wherein the first message is associated with the visual indicia. The first message is printed in a conversational balloon that is visually linked to the visual indicia of the currency.

### CROSS REFERENCE TO RELATED APPLICATIONS

This application claims the benefit of United States Provisional Patent Application No. 60/667,640, filed Mar. 31, 2005, entitled “Greeting Card Integrating Currency and Conversational Balloons”, the contents of which are incorporated herein by reference.

### BACKGROUND OF THE INVENTION

1. Field of the Invention

The present invention relates generally to a greeting card and, more particularly, to a greeting card integrating currency and conversational balloons.

2. Description of Related Art

Prior art greeting cards containing money expose the currency in a manner that shows that the currency is intended as a gift. Thus, prior art greeting cards containing money are primarily utilized to functionally hold the currency therein, at best. For example, U.S. Pat. No. 6,148,550 to Niedfeld discloses a money pocket that is fastened to an internal surface of a greeting card. U.S. Pat. No. 6,978,562 to Frenkel discloses a greeting card elaborately constructed to secure a check or currency therein. The prior art allows for the convenience of giving money as a present contemporaneously with the greeting card, however, the present involves little, if any thought on the giver's part, as the greeting card simply functions as a conduit for transferring money to a recipient. Essentially, the giver of the “present” realizes that all he or she has done is stick money in a card. Therefore, the recipient may view the present as an impersonal or a rushed gift.

Accordingly, there exists a need for a greeting card that transcends the purely currency-holding, functional aspect of the prior art to allow both the giver and the recipient to feel good about the gift.

### SUMMARY OF THE INVENTION

The present invention is a greeting card that uses the artwork inherent in the currency as an integral part of the artwork of the card to deliver an intended message to a recipient. The card of the present invention is not just a holder for the money, but utilizes visual indicia, such as the face on the currency as the person actually speaking the card's message using a cartoon speech balloon, or callout. Therefore, the currency is involved in conveying the card's message. The novelty of the message being given by a fine engraved portrait of a distinguished historical public figure, with the added intrinsic value of the currency, helps both the giver and the recipient to feel good about the gift.

A desirable embodiment greeting card for holding currency includes (a) a print medium having a first and second side, wherein the print medium includes a first fold line; (b) means (e.g., adhesive, a flap, a cut-out, a notch, clip, etc.) for securing the currency to the first side of the print medium to allow a visual indicia depicted on the currency to remain visible after the currency has been secured to the first side; (c) an opening defined within the print medium, wherein the opening allows the visual indicia of the currency to be visible therethrough when the print medium is folded along the first fold line; and (d) a first message printed on the second side of the print medium, wherein the first message is associated with the visual indicia.

The print media may be constructed of card stock, paper, cardboard, or any other suitable material. The first message is printed in a callout, or conversational balloon that is visually linked to the visual indicia of the currency. The callout may include a tail that extends therefrom and is directed toward the opening. Desirably, the opening is either substantially circular or polygonal. More specifically, the opening is sized to substantially correspond to the size of the visual indicia such that the visual indicia are visible and the remainder of the currency is obstructed by the greeting card when the greeting card is folded along the first fold line. A visual guide may be printed on the first side indicating an area in which the currency is to be positioned so as to align the visual indicia with the opening. The first message may appear on a front of the greeting card when the greeting card is folded along the first fold line.

In a desirable embodiment, the greeting card further includes a second fold line such that the first and second fold lines define a first, second, and third panel of the greeting card. Having three separate panels allows a second message to be printed on the first panel, the means for securing the currency to be defined on the second panel, and the callout to be printed on the third panel. Accordingly, the first panel may cover the visual indicia when the greeting card is folded along the first fold line.

Still other desirable features of the invention will become apparent to those of ordinary skill in the art upon reading and understanding the following detailed description, taken with the accompanying drawings.

### BRIEF DESCRIPTION OF THE DRAWINGS

FIG. 1 is a perspective view of a greeting card having currency secured therein, such that visual indicia thereof are visible through an opening of the greeting card, in accordance with the present invention;

FIG. 2 is a perspective view of the greeting card of FIG. 1 in a partially unfolded state;

FIG. 3 is a perspective view of the greeting card of FIG. 1 having a bill placement guide and limited stick adhesive on a first side of the greeting card;

FIG. 4 is a front view of the greeting card of FIG. 1 in a fully unfolded state showing a second side having a first and second message printed thereon; and

FIG. 5 is a front view of the greeting card of FIG. 1 in a fully folded state.

### DETAILED DESCRIPTION OF THE INVENTION

For purposes of the description hereinafter, spatial or directional terms shall relate to the invention as it is oriented in the drawing figures. However, it is to be understood that the invention may assume various alternative variations, except where expressly specified to the contrary. It is also to be understood that the specific apparatus illustrated in the attached drawings, and described in the following specification, is simply an exemplary embodiment of the invention. Hence, specific dimensions and other physical characteristics related to the embodiments disclosed herein are not to be considered as limiting, unless otherwise indicated.

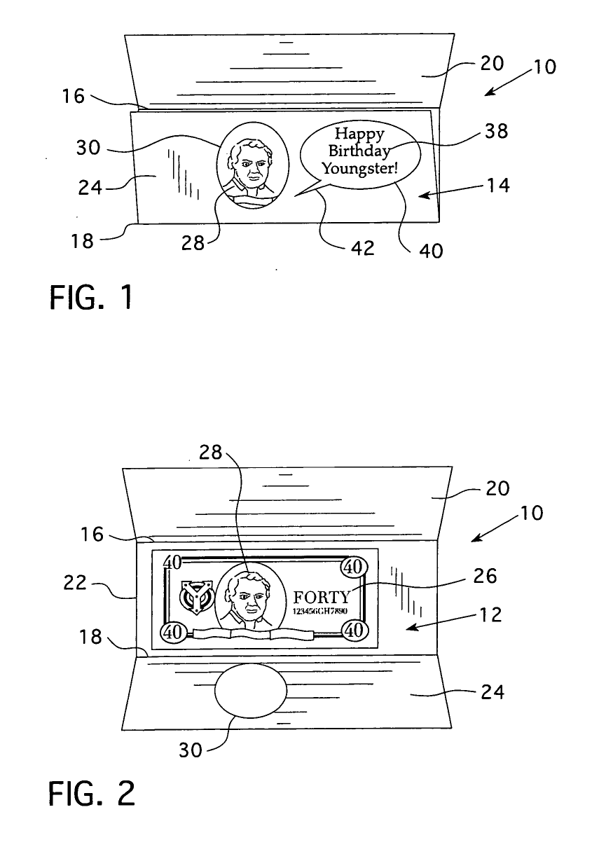

With reference to FIGS. 1-5, a greeting card 10 according to a desirable embodiment of the present invention is shown. The greeting card 10 is constructed of a print medium, such as card stock, paper, cardboard or other suitable material. For example, a tear-resistant plastic material may also be used. Alternatively, a paper-based greeting card may be coated with a laminate. Accordingly, the greeting card may be constructed of both natural and synthetic materials. As distinguished in FIGS. 1 and 2, the greeting card 10 includes a first side 12 and a second side 14, or a front and back side, respectively.

The greeting card 10 includes at least one fold line, such as first fold line 16, so that the greeting card 10 may be folded along the first fold line 16. The greeting card 10, as shown in the accompanying figures, includes another fold line, such as second fold line 18. The greeting card 10 may also be folded along the second fold line 18. The first fold line 16 and the second fold line 18 define a first panel 20, a second panel 22, and a third panel 24 on the greeting card 10. Although the desirable embodiment greeting card 10 includes two folds and three panels, it is to be understood that other greeting cards, having similar novel features as the greeting card 10, may be constructed as a single fold card having a single fold line or a multiple fold card having more than two fold lines. Furthermore, the fold lines of such cards may be defined to provide various folding arrangements. For example, although the greeting card 10 is shown to have fold lines 16, 18 defining substantially equal first, second, and third panels 20, 22, 24, other greeting cards may also include two fold lines that result in a 25/50/25 split of panels (e.g., a greeting card whose left and right panels fold in toward each other and meet in the center of a middle panel). Furthermore, it is envisioned that the greeting card 10 and derivatives thereof may embody identifiable markings to indicate areas in which a fold is to be made. Accordingly, the greeting card 10 may forego any pre-foldings thereof to allow a card giver to fold the card themselves. Therefore, the creative element of the card is further increased.

The desirable embodiment of greeting card 10 is adapted to secure currency 26 therein. Desirably, the currency 26 is a paper bill, such as a five-dollar United States Federal Reserve note. However, it is to be understood that other paper bills of various denominations and/or of foreign origin may also be used in connection with the greeting card 10. The currency 26, depending on the type of currency, may include one or more visual indicia 28. For example, United States currency generally includes a portrait of an individual, namely a United States historical figure, such as Abraham Lincoln. Other visual indicia may include, but are not limited to, the Great Seal of the United States, an eagle, a monument (e.g., The White House). The various visual indicia 28 may be depicted on the front and/or back sides of the currency 26. In an alternative embodiment, the currency 26 may also be coinage, which may also include various visual indicia on opposite sides thereof.

The greeting card 10 also includes an opening 30 defined within the print medium and, more specifically, on the third panel 24 through the first side 12 and the second side 14 thereof. The opening 30 allows the visual indicia 28 of the currency to be visible therethrough when the greeting card 10 is folded along the second fold line 18. The opening 30 may assume any suitable shape including, but not limited to, substantially circular or polygonal. Desirably, the opening 30 is sized to substantially correspond to the size of the visual indicia 28 such that the visual indicia 28 are visible and the remainder of the currency 26 is obstructed by the greeting card 10 when the greeting card is folded along the second fold line 18. For example, as shown in FIG. 1, the opening 30 of the greeting card 10 is oval-shaped to correspond to the oval-shaped portrait of the individual depicted on the currency 26.

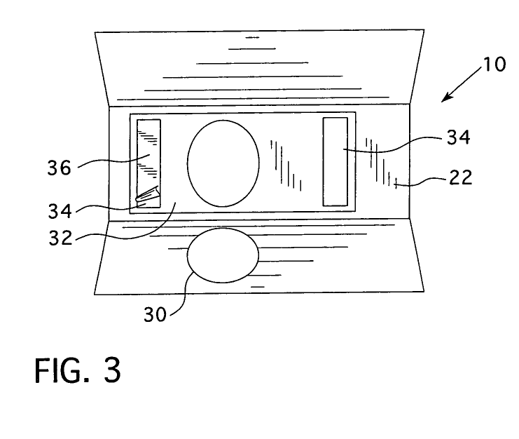

As shown in FIG. 3, a bill placement guide 32 and a limited stick adhesive 34 are situated within the second panel 22 on the first side 12 of the greeting card 10. The bill placement guide 30 may be a visual guide printed on the first side 12 indicating an area in which the currency 26 is to be confined so as to align the visual indicia 28 with the opening 30. Desirably, the limited stick adhesive 34 allows the currency 26 to be securely attached to the greeting card 10 by the card giver, but allows the currency 26 to be removed by a gift recipient without damage to the currency 26 and/or greeting card 10. With respect to the desirable embodiment, the currency 26 is secured to the first side 12 of the greeting card 10 within the second panel 22. The currency 26 is positioned such that the visual indicia 28 thereof remain visible after the currency has been secured to the first side 12. The limited stick adhesive may include a removable backing 36 associated therewith. Therefore, the card giver may be required to peel the removable backing 36 from the limited stick adhesive 34 prior to securing the currency 26 thereagainst. It is to be understood that other forms or holders for securing the currency 26 to the greeting card 10 may be utilized. For example, a flap, slit, cut-out, folded-over tab, notch, clip or combination thereof may be defined within the greeting card 10 under or into which one or more edges or comers of the currency 26 may be inserted. Furthermore, adhesive corner sleeves, similar to the types used to secure photographs in an album, may be used to secure the currency 26 to the greeting card 10. Alternatively, the bill placement guide 32 may be embodied as a pocket or sleeve itself, allowing the bill to be aligned therein. It may be the case that the bill placement guide 32 need not be explicitly marked. For example, notches defined within the greeting card 10 may correspond to the four comers of the currency 26, such that comers of the currency 26 are to be secured along the respective notches. It is to be understood that the greeting card 10 may be adapted to accommodate additional currency behind the visible currency 26. In an alternative embodiment, the limited stick adhesive 34 or other forms of securing the currency 26 may be situated or defined on the third panel 24 of the first side 12. Thus, the second panel 22 remains free of any currency 26 and provides the card giver with additional writing room.

In the desirable embodiment, the greeting card 10 includes a first message 38 printed on the second side 14. As shown in FIG. 1, the first message 38 is printed in a callout 40, or conversational balloon, that is visually linked to the visual indicia 28 of the currency 26. Specifically, a tail 42 extends from the callout 40 and is directed toward the opening 30. After the currency 26 is secured within the greeting card 10 and the greeting card is folded along the second fold line 18, the visual indicia 28 appear through the opening 30. Accordingly, the first message 38, via the callout 40 and the tail 42, is associated within the visual indicia 28 of the currency 26. As shown in FIG. 1, only the visual indicia 28 remain visible once the greeting card 10 is folded along the second fold line 18, as the remainder of the currency 26 is now concealed behind the third panel 24. Accordingly, it will appear to the recipient that a head representing an individual (e.g., Abraham Lincoln) is the speaker of the first message 38. Accordingly, the first message 38 is presented in a personalized and official context. When the greeting card 10 is folded along the first fold line 16, the visual indicia 28 and corresponding callout 40 with the first message 38 are covered. Desirably, it is in this configuration that the greeting card 10 is to be constructed so that the visual indicia 28 are initially concealed upon first viewing of the card by the recipient.

Other parts of artwork or lettering of the currency 26 may be used as the visual indicia 28 appearing through the opening 30. For example, the Great Seal may be used in conjunction with text that indicates that a message from the President is contained inside the greeting card 10. This visual arrangement gives the greeting card an official look. After the greeting card 10 is opened, the President turns out to be the one pictured on the currency 26 whose message is in the callout 40 associated with that currency 26.

In an alternative embodiment, the visual indicia 28 appearing through the opening 30 may be integrated into artwork appearing on the third panel 24 of the second side 14 of the greeting card 10. For example, although the exemplary greeting card 10 discussed herein is designed to display the head of a person pictured on the currency 26 in connection with a callout 40, other variations of displaying the head may be implemented. For example, a Christmas tree may be depicted on the third panel 24 of the second side 14 of the greeting card 10. The Christmas tree may include a variety of tree ornamentation, such as hanging bulb or ball ornaments. One of the bulb or ball ornaments depicted on the Christmas tree may correspond to the opening 30. Therefore, the visual indicia 28, such as a head of the individual depicted on the currency 26, would show through the opening 30 and appear to be a part of the Christmas tree. In addition, the Christmas tree may have a conversational balloon associated with it, which would give the appearance that the Christmas tree or the head in the Christmas tree is speaking. It is to be understood that other themes, including other holiday themes, may be used in connection with the present invention. For example, an Easter card may utilize the opening 30 in the form of an Easter egg. Still, in another embodiment, the opening 30 may be in the form of a present and a ribbon corresponding to the present may be printed above the opening 30.

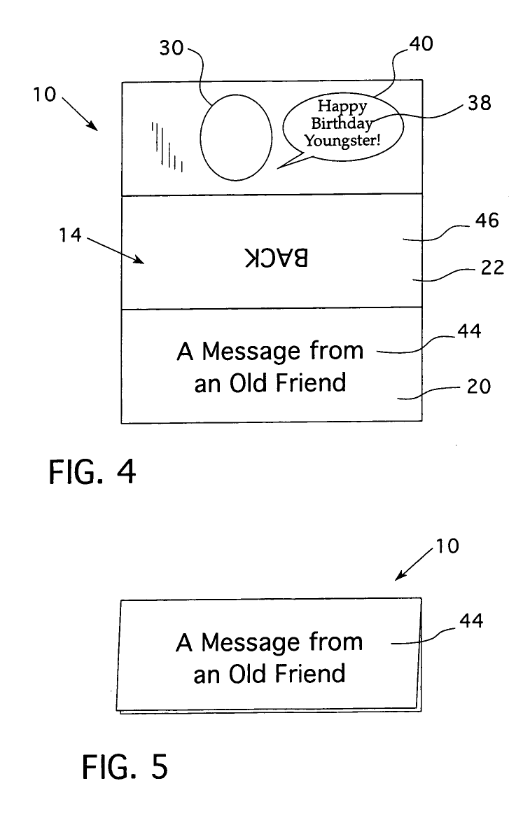

In the desirable embodiment, as shown in FIGS. 4 and 5, a second message 44 may be displayed on the first panel 20 of the second side 14 of the greeting card 10. The first panel 20 acts as the front of the greeting card 10. Therefore, the second message 44 may serve the function of an initial greeting to the recipient. Optionally, the back of the greeting card, such as on the second panel 22 thereof, may include additional text. For example, a copyright message 46 may be displayed.

It is to be understood that the greeting card 10 may be embodied in a variety of configurations. This includes, but is not limited to, the folds or the orientation of the various components inherent in the card. Thus, the novel features discussed herein may be incorporated into any suitable card regardless of the initial greeting, conversational balloon, and type of currency used in connection with the greeting card 10. In an alternative embodiment, the callout 40 may be empty (i.e., no predefined text) to allow the card giver to write a personalized message within the callout 40. Accordingly, the creative element of the card is further increased. The present invention may also be modified such that instead of currency, a photograph is secured within the greeting card 10 and a head or full-figure of an individual depicted in the photograph appears through a respective opening of the greeting card 10.

The present invention has been described with reference to the preferred embodiments. Modifications, combinations and alterations will occur to others upon reading the preceding detailed description. It is intended that the invention be construed as including all such modifications, combinations and alterations insofar as they come within the scope of the appended claims or the equivalents thereof.

The invention claimed is:

1. A greeting card for holding currency, wherein the greeting card comprises:
a print medium having a first and second side, wherein the print medium includes a first fold line;
means for securing the currency to the first side of the print medium to allow a visual indicia depicted on the currency to remain visible after the currency has been secured to the first side;
an opening defined within the print medium, wherein the opening allows the visual indicia of the currency to be visible therethrough when the print medium is folded along the first fold line; and
a first message printed on the second side of the print medium, wherein the first message is associated with the visual indicia.

2. The greeting card of claim 1, wherein the first message is printed in a callout that is visually linked to the visual indicia of the currency.

3. The greeting card of claim 2, wherein the callout is visually linked by a tail extending therefrom and is directed toward the opening.

4. The greeting card of claim 1, wherein the means for securing the currency include one of an adhesive, a flap, a slit, a cut-out, a folded-over tab, a notch and a clip.

5. The greeting card of claim 4, wherein the adhesive includes a removable backing.

6. The greeting card of claim 1, wherein the opening is one of substantially circular and polygonal.

7. The greeting card of claim 6, wherein the opening is sized to substantially correspond to the size of the visual indicia such that the visual indicia are visible and the remainder of the currency is obstructed by the greeting card when the greeting card is folded along the first fold line.

8. The greeting card of claim 1, further comprising a visual guide printed on the first side indicating an area in which the currency is to be positioned so as to align the visual indicia with the opening.

9. The greeting card of claim 1, wherein the print media is one of card stock, paper and cardboard.

10. The greeting card of claim 1, wherein the first message appears on a front of the greeting card when the greeting card is folded along the first fold line.

11. The greeting card of claim 1, further comprising a second fold line, wherein the first and second fold lines define a first, second and third panel of the greeting card.

12. The greeting card of claim 11, wherein a second message is printed on the first panel, the means for securing the currency is defined on the second panel, and the callout is printed on the third panel.

13. The greeting card of claim 12, wherein the first panel covers the visual indicia when the greeting card is folded along the first fold line.

14. A greeting card for holding currency, wherein the greeting card comprises:
a print medium having a fold line defining an inside portion and an outside portion when the greeting card is folded along the fold line;
means for securing the currency on the inside portion; and
an opening that allows a visual indicia of the currency to be visible through the opening when currency is secured to the means for securing the currency.

15. The greeting card of claim 14, further comprising a message printed on the outside portion, wherein the message is printed in a callout that is visually associated with the visual indicia of the currency.

16. The greeting card of claim 15, wherein the visual indicium is a portrait of a United States historical figure.

17. The greeting card of claim 15, wherein the opening is sized to substantially correspond to the size of the visual indicia such that the visual indicia are visible and the remainder of the currency is obstructed by the greeting card when the greeting card is folded along the fold line.

18. A greeting card for holding currency, wherein the greeting card comprises:
a print medium comprising a first and second fold line, wherein the first and second fold lines define a first, second and third panel of the print medium;
an opening defined within the third panel of the print medium;
a bill placement guide defined on the second panel of a first side of the print medium, wherein the bill placement guide indicates an area in which the currency is to be positioned so as to align a portrait thereof with the opening and to display the portrait through the opening;
an adhesive attached on the second panel of the first side of the print medium; and
a callout printed on the third panel of a second side of the print medium, wherein the callout includes a tail extending toward the opening, further wherein a first message is printed within the callout.

19. The greeting card of claim 18, further comprising a second message printed on the first panel of the second side of the print medium.

20. The greeting card of claim 19, wherein the adhesive includes a removable backing.
